(19) United States
(12) Patent Application Publication
(10) Pub. No.: US 2025/0121740 A1
(43) Pub. Date: Apr. 17, 2025

(54) SEAT MOUNTING STRUCTURE FOR A VEHICLE

(71) Applicants: HYUNDAI MOTOR COMPANY, Seoul (KR); KIA CORPORATION, Seoul (KR)

(72) Inventors: Seung Min Jeong, Hwaseong-si (KR); Joo Nam Kim, Seoul (KR)

(73) Assignees: HYUNDAI MOTOR COMPANY, Seoul (KR); KIA CORPORATION, Seoul (KR)

(21) Appl. No.: 18/657,291

(22) Filed: May 7, 2024

(30) Foreign Application Priority Data
Oct. 13, 2023 (KR) 10-2023-0136732

(51) Int. Cl. B60N 2/015; B60N 2/07

(52) U.S. Cl. CPC B60N 2/015; B60N 2/07

(57) ABSTRACT

A seat mounting structure may include a floor panel that covers an upper side of a battery accommodation space and is provided with a top wall and a bottom wall spaced apart from each other in an upward and downward direction; and a plurality of partition walls configured to connect the top wall and the bottom wall The seat mounting structure may further include: a seat mounting reinforcement bracket configured to be inserted into a space that the top wall, the bottom wall, and the partition walls form together; a seat mounted in an upper direction on the floor panel; and a fastening member configured to be fastened by penetrating the top wall so that the seat is secured to the floor panel.

### CROSS REFERENCE TO RELATED APPLICATION

The present application claims priority to Korean Patent Application No. 10-2023-0136732, filed Oct. 13, 2023, the entire contents of which is incorporated herein for all purposes by this reference.

### BACKGROUND

### Technical Field

The present disclosure relates to a seat mounting structure for a vehicle.

### Description of the Related Art

An electric vehicle operates by propelling a motor using electricity supplied from a battery installed within the vehicle.

Therefore, a cruising range of the vehicle depends greatly on an energy storage capacity of the battery mounted on the vehicle.

An important challenge in electric vehicle development is to secure the various crash response capabilities while equipping the vehicle with a battery storing as much electrical energy as possible.

Recently, in order to increase the number of battery cells mounted on the vehicle, a cell to body (CTB) vehicle structure has been developed, in which battery cells are mounted directly on the vehicle body.

In this case, the battery cells may be located directly below a floor panel on which various parts, such as vehicle seats, are installed.

The seats are regulated by law to be prevented from coming off even when a specified load is applied while being mounted on the floor panel. Therefore, during assembly of the seats, the seats are required not to affect the battery cells on a lower-side (e.g., underneath of the seats), while also ensuring that the seats are securely fixed to the floor panel with sufficient rigidity.

The foregoing is intended merely to assist in understanding of the background of the present disclosure, and is not intended to mean that the background information falls within the purview of the related art that is already known to those having ordinary skill in the art.

### SUMMARY

The present disclosure has been made keeping in mind the above problems occurring in the related art, and the present disclosure provides a seat mounting structure for a vehicle that strongly secures seats with sufficient rigidity to an upper side of a floor panel that accommodates a battery storage space on the lower side, thereby ensuring that the seats remain firmly supported and do not separate from the floor panel in the event of a vehicle collision or similar incidents. Accordingly, the vehicle complies with the requirements of various laws and regulations regarding seat mounting and enhancing passenger safety.

In order to achieve the above objective, according to the present disclosure, there may be provided a seat mounting structure for a vehicle. The seat mounting structure includes: a floor panel that covers an upper side of a battery accommodation space and is provided with a top wall and a bottom wall, which are spaced apart from each other in an upward and downward direction of the vehicle. The seat mounting structure further includes: a plurality of partition walls configured to connect the top wall and the bottom wall in the upward and downward direction; a seat mounting reinforcement bracket configured to be inserted into a space that is defined by the top wall, the bottom wall, and the partition walls; a seat mounted in an upper direction on the floor panel; and a fastening member configured to be fastened by penetrating the top wall so that the seat is secured to the floor panel.

The seat mounting reinforcement bracket may be provided with a weld nut to which the fastening member is fastened.

The seat mounting reinforcement bracket may be provided with an upper portion configured to come into contact with the top wall of the floor panel and lateral portions configured to respectively come into contact with opposite partitions.

The partition wall may be integrally provided with a locking rib protruding toward the seat mounting reinforcement bracket.

The lateral portion of the seat mounting reinforcement bracket may be provided with a curved bending portion configured to come into contact with a lower side of the locking rib.

The partition wall may be extended in a transverse direction of a vehicle body. The seat may be secured to the floor panel using seat rails configured to extend in a longitudinal direction of the vehicle body, and the seat mounting reinforcement bracket may be extended along the transverse direction of the vehicle body.

The seat mounting reinforcement bracket may be configured to have a length greater than a transverse width of the seat rail.

The floor panel may include: a basic floor portion including a top wall; and a mounting floor portion having a top wall configured to have a height greater than a height of the top wall of the basic floor portion. In particular, the seat mounting reinforcement bracket is configured to be inserted into a lower side of the top wall of the mounting floor portion.

In another embodiment of the present disclosure, a seat mounting structure for a vehicle includes: a floor panel made of constant extruded material along a transverse direction of a vehicle body and including a plurality of closed cross-sections. The floor panel encloses an upper side of a battery accommodation space. The seat mounting structure further includes: a seat mounted in an upper direction on the floor panel; a seat mounting reinforcement bracket configured to be inserted into at least one of the closed cross-sections of the floor panel; and a fastening member configured to secure the seat to the seat mounting reinforcement bracket.

The seat mounting reinforcement bracket may include: lateral portions respectively extending downward along opposite partition walls constituting the closed cross-section of the floor panel; and an upper portion connecting the lateral portions of opposite sides to each other.

The upper portion of the seat mounting reinforcement bracket may be provided with a weld nut to which the fastening member is fastened.

The partition wall of the floor panel may be provided integrally with a locking rib protruding toward the seat mounting reinforcement bracket.

A curved bending portion may be provided on each of the lateral portions of the seat mounting reinforcement bracket so as to be restricted from moving in the upper direction by being caught by the locking rib when the seat mounting reinforcement bracket is pulled in the upper direction.

The seat may be secured to the floor panel using seat rails that guide sliding of the seat in a longitudinal direction relative to the floor panel, and the fastening member may be fastened so as to secure the seat rail to the seat mounting reinforcement bracket.

A length of the seat mounting reinforcement bracket along the transverse direction of the vehicle body may be greater than a width of the seat rail.

The floor panel may be constituted by connecting a plurality of extruded panels to each other in anteroposterior directions (i.e., a forward-backward direction) of the vehicle body. The closed cross-sections of the floor panel may form a structure, in which a mounting floor portion and a basic floor portion coexist in the upper direction. A height of the basic floor portion is less than a height of the mounting floor portion.

The seat mounting reinforcement bracket may be configured to be inserted into a closed cross-section constituting the mounting floor portion in the upper direction; and the seat rail may be configured to be secured to the mounting floor portions of the floor panel.

As described above, the present disclosure provides a seat mounting structure for a vehicle that can strongly secure seats with sufficient rigidity in an upper direction to a floor panel containing a battery storage space below, ensuring that the seats can remain firmly supported and do not separate from the floor panel in the event of a vehicle collision or similar incidents, thereby complying with the requirements of various laws and regulations regarding seat mounting and enhancing passenger safety.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a view illustrating a seat mounting structure of a vehicle according to an embodiment of the present disclosure;

FIG. 2 is a detailed view showing in detail a floor panel and a seat rail of FIG. 1;

FIG. 3 is a view showing a state in which the floor panel is omitted from FIG. 2;

FIG. 4 is a view of FIG. 2 viewed from below;

FIG. 5 is a view showing a state in which the floor panel is omitted from FIG. 4;

FIG. 6 is a sectional view taken along line VI-VI of FIG. 1;

FIG. 7 is a detailed view of part VII of FIG. 6; and

FIG. 8 is a sectional view taken along line VIII-VIII of FIG. 1.

### DETAILED DESCRIPTION

Hereinafter, the embodiments disclosed in the present specification are described in detail with reference to the accompanying drawings, but the same or similar components are assigned the same reference numerals regardless of reference numerals, and overlapping descriptions thereof have been omitted.

The terms “module” and “part” for the components used in the following description are given or mixed in consideration of only the ease of writing the specification and do not have distinct meanings or roles by themselves.

In describing the embodiments disclosed in the present disclosure, when it is determined that detailed descriptions of related known technologies may obfuscate the gist of the embodiments disclosed in the present disclosure, the detailed description thereof has been omitted. In addition, the accompanying drawings are only to aid in understanding of the embodiments disclosed in the present disclosure, and the technical idea disclosed herein is not limited by the accompanying drawings, and all changes included in the spirit and scope of the present disclosure should be understood to include equivalents or substitutes.

Terms including ordinal numbers such as first, second, and the like may be used to describe various elements, but the elements are not limited by the terms. The above terms are used only for the purpose of distinguishing one component from another.

When a component is referred to as being “connected” or “coupled” to another component, it may be directly connected or coupled to another component, but it should be understood that other components may exist in between. On the other hand, when a component is referred to as being “directly connected” or “directly connected” to another component, it should be understood that there are no other components in between.

A singular expression includes a plural expression unless the context clearly dictates otherwise. When a component, device, element, or the like of the present disclosure is described as having a purpose or performing an operation, function, or the like, the component, device, or element should be considered herein as being “configured to” meet that purpose or to perform that operation or function.

In the present specification, terms such as “comprises” or “have” are intended to designate that the features, numbers, steps, operations, components, parts, or combinations thereof described in the specification exist and should be understood that it does not preclude the possibility of addition or existence of one or more other features, numbers, steps, operations, components, parts, or combinations thereof.

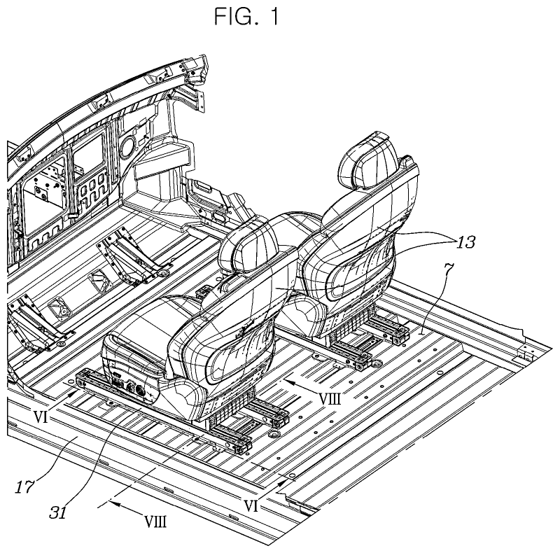

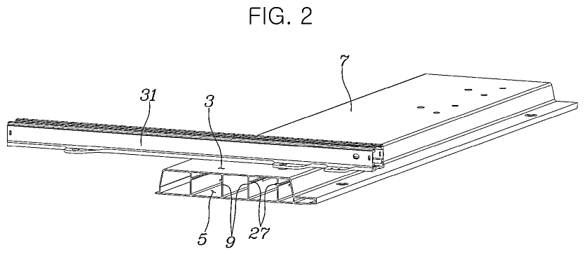

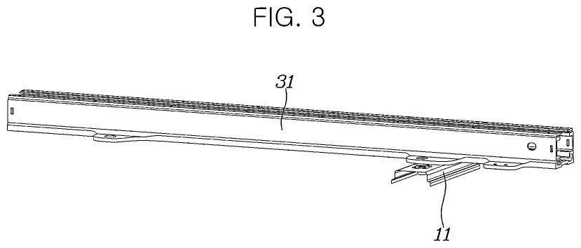

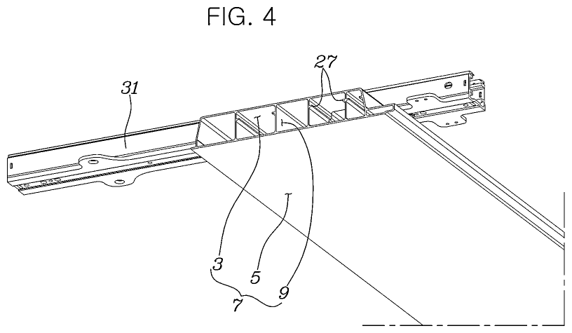

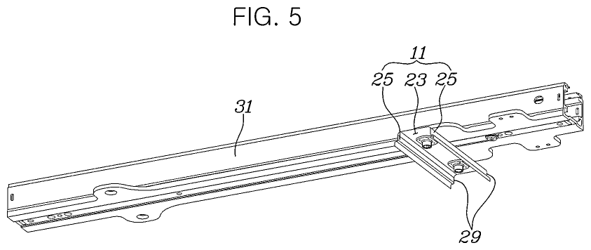

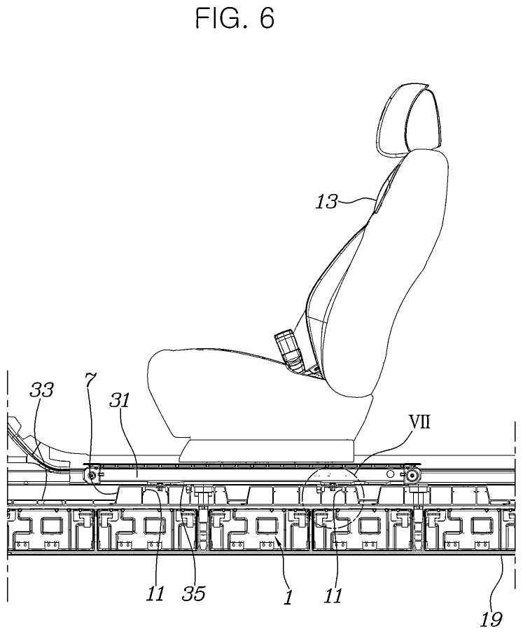

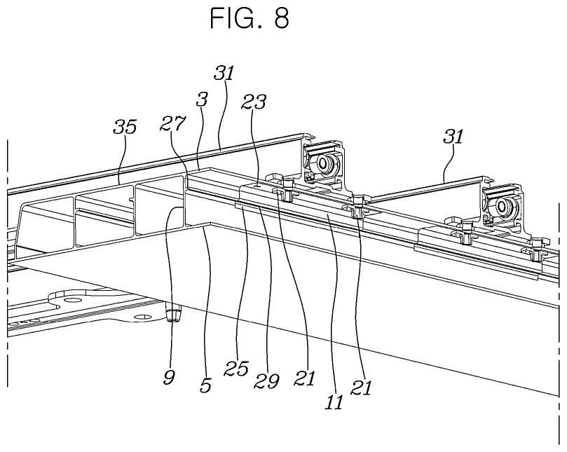

In an embodiment of the present disclosure, with reference to FIGS. 1 to 8, a seat mounting structure of a vehicle includes: a floor panel 7 located in an upper direction of a battery accommodation space 1 and provided with a top wall 3 and a bottom wall 5 spaced apart from each other in an upward and downward direction of the vehicle. The seat mounting structure also includes: a plurality of partition walls 9 configured to connect the top wall 3 and the bottom wall 5; and a seat mounting reinforcement bracket 11 configured to be inserted into a space that the top wall 3, the bottom wall 5 and the partition walls 9 form together. The seat mounting structure may further include a seat 13 mounted in an upper direction on the floor panel 7. The seat mounting structure may further include a fastening member configured to be fastened by penetrating the top wall 3 so 15 that the seat 13 is secured to the floor panel 7.

In other words, the present disclosure is configured to mount the seat 13 in an upper direction on the floor panel 7 located in an upper direction of the battery accommodation space 1. In particular, the seat 13 is secured to the mounting reinforcement bracket 11, which has been inserted into the floor panel 7, utilizing the fastening member 15.

The battery accommodation space 1 refers to a space that directly accommodates battery modules or battery cells, and the floor panel 7 is a structure configured to be fastened to side sills 17 on opposite sides of a vehicle body, thereby constituting the battery accommodation space 1 together with the side sills 17. In this regard, the structure of a present embodiment may be seen as substantially implementing a CTB-type vehicle structure in which battery cells are installed directly inside the vehicle body.

For reference, here, the lower side of the battery accommodation space 1 has a structure surrounded by a separate battery tray 19.

This is different from a conventional method of additionally mounting a battery pack and the like, which separately accommodates battery cells, to the vehicle body.

Naturally, the CTB-type vehicle structure, as described above, eliminates the need for a battery pack case, which is a component of a conventional battery pack and the like. Therefore, this not only reduces the weight of the vehicle but also increases the battery pack's loading capacity, making it advantageous for extending a cruising range.

As described above, the floor panel 7 includes a structure having the top wall 3 and the bottom wall 5 spaced apart from each other in an upward and downward direction of the vehicle. Therefore, even when fastening members 15 for mounting parts such as seats 13 are fastened to the upper direction of the floor panel 7, there is an advantage in structurally preventing the fastening members 15 from invading the lower battery accommodation space 1.

For reference, the fastening members 15 may be bolts, screws, or the like.

In addition, a structure, in which a gap between the top wall 3 and the bottom wall 5 is connected by the plurality of partition walls 9 as described above, enhances rigidity of the floor panel 7 itself. As a result, even when a heavy object, such as the seat 13, is mounted, the structure helps achieve a solid and stable support state. This, in turn, allows the battery cells accommodated in the lower battery accommodation space 1 to be more safely protected from the outside.

For reference, the floor panel 7 as described above may be constructed by arranging a plurality of extruded panels to be connected along an anteroposterior direction of the vehicle body.

The seat mounting reinforcement bracket 11 is provided with a weld nut 21 to which the fastening member 15 is fastened.

The seat mounting reinforcement bracket 11 has an upper portion 23 in contact with the top wall 3 of the floor panel 7 and lateral portions 25 each in contact with corresponding one of opposite partition walls 9 adjacent thereto.

Therefore, the weld nut 21 is located between the opposite lateral portions 25, and a force applied by the fastening member 15 may be transferred to the opposite lateral portions 25 through the weld nut 21.

The partition wall 9 is integrally provided with a locking rib 27 protruding toward the seat mounting reinforcement bracket 11.

In addition, the lateral portion 25 of the seat mounting reinforcement bracket is structured to be provided with a curved bending portion 29 configured to come into contact with a lower side of the locking rib 27.

Therefore, when the fastening member 15 receives a load pulled in the upper direction, it results in a state where the load is transferred to the lateral portions 25 through the weld nut 21 and the upper portion 23 of the seat mounting reinforcement bracket 11. Subsequently, the load is again transferred to the locking ribs 27 through the bending portions 29.

Therefore, as described above, the load acting on the fastening member 15 may be distributed to the upper portion 23 and the opposite lateral portions 25 of the seat mounting reinforcement bracket 11 so as to be supported very strongly and stably.

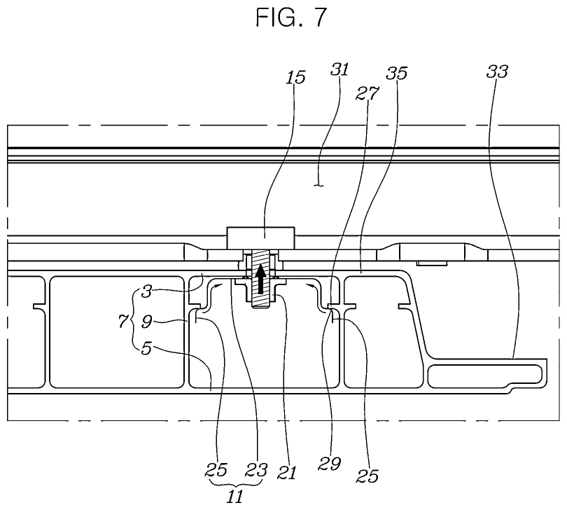

For reference, arrows in FIG. 7 illustrate that the load, acting in the upper direction on the fastening member 15, is distributed to the opposite lateral portions 25 through the upper portion 23 of the seat mounting reinforcement bracket 11.

The partition walls 9 are each extended in a transverse direction of the vehicle body, the seats 13 are each secured to the floor panel 7 through seat rails 31 extended in a longitudinal direction of the vehicle body, and the seat mounting reinforcement brackets 11 are each extended along the transverse direction of the vehicle body.

Furthermore, the seat mounting reinforcement bracket 11 has a length greater than the transverse width of the seat rail 31.

Thus, the seat 13, located in the upper direction on the floor panel 7, the seat 13 is firmly secured to and supported on the floor panel 7 by the seat rail 31 and the fastening member 15. In particular, the fastening member 15 penetrates the top wall 3 of the floor panel 7 and fastens to the weld nut 21 of the seat mounting reinforcement bracket 11.

In one embodiment, the floor panel 7 includes: a basic floor portion 33 in which the top wall 3 has a relatively low height; and a mounting floor portion 35 in which the height of the top wall 3 is provided to be relatively high with respect to the basic floor portion 33. The seat mounting reinforcement bracket 11 is inserted into a lower side of the top wall 3 of the mounting floor portion 35.

The mounting floor portion 35 features a relatively high top wall 3, allowing insertion of the seat mounting reinforcement bracket 11 to be easily made. Therefore, the seat mounting reinforcement bracket 11 is inserted into the lower side of the top wall 3 of the mounting floor portion 35, thereby improving assembly and simultaneously increasing a section modulus of the portion directly supporting the seat rail 31 and the seat 13. As a consequence, this may ensure a more robust mounting state of the seat 13.

The present disclosure as described above may be expressed as follows.

In other words, the seat mounting structure of the vehicle of the present disclosure includes: a floor panel 7 made of constant extruded material along a transverse direction of a vehicle body, and the sectional shape of the floor panel 7 comprises a plurality of closed cross-sections. The floor panel 7 encloses an upper side of a battery accommodation space 1. The seat mounting structure also includes a seat 13 mounted in an upper direction on the floor panel 7; a seat mounting reinforcement bracket 11 configured to be inserted into at least one of the closed cross-sections of the floor panel 7; and a fastening member 15 configured to secure the seat 13 to the seat mounting reinforcement bracket 11.

The seat mounting reinforcement bracket 11 includes: lateral portions 25 respectively extending downward along opposite partition walls 9 constituting the closed cross-section of the floor panel 7; and an upper portion 23 connecting the lateral portions 25 of opposite sides.

The upper portion 23 of the seat mounting reinforcement bracket 11 is provided with a weld nut 21 to which the fastening member 15 is fastened.

The partition wall 9 of the floor panel 7 is provided integrally with a locking rib 27 protruding toward the seat mounting reinforcement bracket 11.

A curved bending portion 29 is provided on each of the lateral portions 25 of the seat mounting reinforcement bracket 11 so as to be restricted from moving in the upper direction by being caught by the locking rib 27 when the seat mounting reinforcement bracket 11 is pulled in the upper direction.

The seat 13 is structured to be secured to the floor panel 7 utilizing seat rails 31 that guide sliding of the seat 13 in a longitudinal direction relative to the floor panel 7, and the fastening members 15 are structured to be fastened so as to secure the seat rail to the seat mounting reinforcement bracket 11.

A length of the seat mounting reinforcement bracket 11 along a transverse direction of the vehicle body is provided to be greater than a width of the seat rail 31.

Accordingly, the seat mounting reinforcement bracket 11 may come into contact with the floor panel 7 over a larger area, providing more robust support.

The floor panel 7 is constituted by connecting a plurality of extruded panels in the anteroposterior direction of the vehicle body; and the closed cross-section of the floor panel 7 is a structure, in which, in the upper direction, there coexist a mounting floor portion 35, whose height is relatively high in an upward and downward direction, and a basic floor portion 33, whose height is relatively low in the upward and downward direction.

The seat mounting reinforcement bracket 11 is inserted into the closed crossed-section that constitutes in the upper direction the mounting floor portion 35, and the seat rail 31 is secured to the mounting floor portion 35 of the floor panel 7.

Although the present disclosure has been shown and described with respect to specific embodiments, without departing from the technical spirit of the present disclosure as provided by the following claims, it should be apparent to those having ordinary skill in the art that the present disclosure may be improved and changed in various ways.

What is claimed is:

1. A seat mounting structure for a vehicle, the seat mounting structure comprising:
a floor panel configured to cover an upper side of a battery accommodation space and including: a top wall, and a bottom wall spaced apart from the top wall in an upward and downward direction of the vehicle;
a plurality of partition walls configured to connect the top wall and the bottom wall in the upward and downward direction;
a seat mounting reinforcement bracket configured to be inserted into a space that is defined by the top wall, the bottom wall, and the partition walls;
a seat mounted in an upper direction on the floor panel; and
a fastening member configured to be fastened by penetrating the top wall so that the seat is secured to the floor panel.

2. The seat mounting structure of claim 1, wherein the seat mounting reinforcement bracket is provided with a weld nut to which the fastening member is fastened.

3. The seat mounting structure of claim 1, wherein the seat mounting reinforcement bracket includes:
an upper portion configured to come into contact with the top wall of the floor panel; and
lateral portions configured to respectively come into contact with opposite partitions.

4. The seat mounting structure of claim 3, wherein the partition wall is integrally provided with a locking rib protruding toward the seat mounting reinforcement bracket.

5. The seat mounting structure of claim 4, wherein the lateral portions of the seat mounting reinforcement bracket are respectively provided with a curved bending portion configured to come into contact with a lower side of the locking rib.

6. The seat mounting structure of claim 4, wherein the partition wall is extended in a transverse direction of a vehicle body;
the seat is secured to the floor panel using seat rails configured to extend in a longitudinal direction of the vehicle body; and
the seat mounting reinforcement bracket is configured to extend along the transverse direction of the vehicle body.

7. The seat mounting structure of claim 6, wherein, the seat mounting reinforcement bracket is configured to have a length greater than a transverse width of a seat rail of the seat rails.

8. The seat mounting structure of claim 1, wherein the floor panel comprises:
a basic floor portion including a top wall; and
a mounting floor portion including a top wall configured to have a height greater than a height of the top wall of the basic floor portion,
wherein the seat mounting reinforcement bracket is configured to be inserted into a lower side of the top wall of the mounting floor portion.

9. A seat mounting structure for a vehicle, the seat mounting structure comprising:
a floor panel made of constant extruded material along a transverse direction of a vehicle body, and including a plurality of closed cross-sections, the floor panel configured to enclose an upper side of a battery accommodation space;
a seat mounted in an upper direction on the floor panel;
a seat mounting reinforcement bracket configured to be inserted into at least one of the plurality of closed cross-sections of the floor panel; and
a fastening member configured to secure the seat to the seat mounting reinforcement bracket.

10. The seat mounting structure of claim 9, wherein the seat mounting reinforcement bracket comprises:
lateral portions respectively extending downward along opposite partition walls constituting the plurality of closed cross-sections of the floor panel; and
an upper portion connecting the lateral portions to each other.

11. The seat mounting structure of claim 10, wherein the upper portion of the seat mounting reinforcement bracket is provided with a weld nut to which the fastening member is fastened.

12. The seat mounting structure of claim 10, wherein the partition walls of the floor panel are provided integrally with a locking rib protruding toward the seat mounting reinforcement bracket.

13. The seat mounting structure of claim 12, wherein a curved bending portion is provided on each of the lateral portions of the seat mounting reinforcement bracket so as to be restricted from moving in the upper direction by being caught by the locking rib when the seat mounting reinforcement bracket is pulled in the upper direction.

14. The seat mounting structure of claim 9, wherein the seat is secured to the floor panel using seat rails that guide sliding of the seat in a longitudinal direction relative to the floor panel; and
the fastening member is fastened so as to secure the seat rails to the seat mounting reinforcement bracket.

15. The seat mounting structure of claim 14, wherein a length of the seat mounting reinforcement bracket along the transverse direction of the vehicle body is greater than a width of a seat rail of the seat rails.

16. The seat mounting structure of claim 14, wherein the floor panel is constituted by connecting a plurality of extruded panels to each other in anteroposterior directions of the vehicle body; and
the plurality of closed cross-sections of the floor panel forms a structure, in which a mounting floor portion and a basic floor portion coexist in the upper direction, wherein a height of the basic floor portion is less than a height of the mounting floor portion.

17. The seat mounting structure of claim 16, wherein the seat mounting reinforcement bracket is configured to be inserted into a closed cross-section constituting the mounting floor portion in the upper direction; and
the seat rails are configured to be secured to the mounting floor portions of the floor panel.
